(19) United States
(12) Patent Application Publication
(10) Pub. No.: US 2004/0074128 A1
(43) Pub. Date: Apr. 22, 2004

(54) Promotional assembly

(76) Inventors: Scott D. Best, Troy, MI (US); James F. Turner, Farmington Hills, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/649,101

(22) Filed: Aug. 27, 2003

Related U.S. Application Data
(60) Provisional application No. 60/406,276, filed on Aug. 27, 2002.
(60) Provisional application No. 60/425,090, filed on Nov. 8, 2002.

(51) Int. Cl. G09F 3/10

(52) U.S. Cl. 40/674; 40/673

(57) ABSTRACT

A promotional assembly has a first layer of material and a second layer of material with a liner sandwiched therebetween. Score lines are cut through the layers of material and the liner to define one of two promotional assemblies, namely an advertising portion with a coupon card portion or a sticker portion with a coupon card portion. The advertising portion has a hanging section defining an opening for mounting the promotional assembly. Advertising areas are also disposed on the advertising portion for conveying various advertising information. The first and second layers of material for the sticker portion are further defined as first and second flexible film layers having a specific thickness. The coupon card portion has a number of removable mini-coupons that can be subsequently detached and redeemed.

### RELATED APPLICATIONS

The subject patent application claims priority to and all the benefits of U.S. Provisional patent applications serial No. 60/406,276, filed on Aug. 27, 2002, and serial No. 60/425,090, filed on Nov. 8, 2002.

### BACKGROUND OF THE INVENTION

1. Field of the Invention

The subject invention relates to promotional assemblies which convey advertising and marketing information to a user.

2. Description of the Prior Art

Promotional assemblies are well known and are used for various purposes to encourage users to visit a particular establishment, purchase a particular item, obtain information relating to a particular event or organization, and/or promote a particular company. Promotional assemblies often set forth the name of the company or organization, the name of the product or service being advertised, and location information on how to obtain the product or service. Promotional assemblies can come in a variety of forms and may be distributed to the public through any variety of means such as direct mail, newspaper inserts, and/or magazine inserts.

Some promotional assemblies also include coupons to encourage the users to purchase a particular item or service and/or to return to a particular establishment. U.S. Pat. Nos. 6,092,841 and 6,228,451 each disclose promotional assemblies having one or more coupons attached thereto. Many of the promotional assemblies with coupons, however, are formed of inferior materials, do not retain sufficient structural integrity after the coupons are removed, and/or are not configured in the most efficient manner.

Promotional assemblies can also be in the form of stickers. Stickers are also well known and are frequently distributed to promote a company or logo, express and idea or opinion, and/or to simply use. The stickers of the prior art, however, are not combined with coupons to provide a dual purpose/play value for the user.

Accordingly, it would be desirable to develop a promotional assembly having a coupon portion that overcomes the deficiencies of the prior art, is easy to use and inexpensive to manufacture. In other words, it would be desirable to develop a promotional assembly that adequately conveys the desired advertising information while simultaneously promoting an establishment.

### SUMMARY OF THE INVENTION AND ADVANTAGES

A promotional assembly comprising a first layer of material having an exterior surface and an interior surface. A liner is adhered to the interior surface of the first layer of material. A second layer of material has an exterior surface and an interior surface with the interior surface of the second layer of material being adhered to the liner to sandwich the liner between the first and second layers of material. A plurality of first score lines are cut through the first layer of material, the liner, and the second layer of material to define an advertising portion and a coupon card portion with the portions being separable from each other. In a first embodiment, the advertising portion has a hanging section defining an opening for mounting the assembly. Advertising areas are defined on the exterior surfaces of the advertising portion with the advertising areas having promotional printed matter imprinted on at least one of the exterior surfaces for conveying various advertising information to a user and for providing a marketing aspect to the assembly. A plurality of second score lines are cut through the second layer of material on the coupon card portion to define a plurality of removable mini-coupons that can be subsequently detached from the coupon card portion for allowing a user of the assembly to redeem the mini-coupons.

In another embodiment of the subject invention, the first layer of material is defined as a first flexible film layer having a thickness of from 1.0 mil to 8.0 mils. The liner is formed of a paper card stock having a thickness of from 2.8 mils to 9.0 mils. The second layer of material is defined as a second flexible film layer having a thickness of from 1.0 mil to 8.0 mils. The plurality of first score lines are cut through the first flexible film layer, the liner, and the second flexible film layer to define a sticker portion and a coupon card portion with the portions being separable from each other. At least one of the first and second flexible film layers on the sticker portion are removable from the liner for allowing a user to transpose the first and second flexible film layers from the sticker portion to another substrate. Printed matter is imprinted on at least one of the exterior surfaces of the sticker portion for conveying various pictorial, graphical, and text messages to the user thereby encouraging the user to remove at least one of the first and second flexible film layers on the sticker portion. A plurality of second score lines are cut through the second flexible film layer on the coupon card portion to define a plurality of removable mini-coupons that can be subsequently detached from the coupon card portion for allowing the user of the assembly to redeem the mini-coupons in addition to utilizing the sticker portion.

Accordingly, in the first embodiment, the subject invention overcomes the deficiencies in the prior art by providing a promotional assembly having an advertising portion and a coupon card portion that is easy to use, inexpensive to manufacture, can be hung from a hook, door knob, or the like, and retains its rigidity once the coupons are removed. In the second embodiment, the subject invention overcomes the deficiencies in the prior art by providing a promotional assembly having a sticker portion and a coupon card portion that is easy to use, inexpensive to manufacture, adequately promotes an establishment while simultaneously be fun to use.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of a promotional assembly in accordance with the subject invention in one contemplated environment;

FIG. 2 is a perspective view of the promotional assembly;

FIG. 3 is a front planar view of the promotional assembly of FIG. 2;

FIG. 4 is a back planar view of the promotional assembly of FIG. 2;

FIG. 5 is a cross-sectional view of the promotional assembly of FIG. 2;

FIG. 6 is another cross-sectional view of the promotional assembly of FIG. 2;

FIG. 7 is a cross-sectional view of the promotional assembly of FIG. 2 illustrating a score line cut through a portion of the assembly;

FIG. 8 is a top view of a series of promotional assemblies during a manufacture thereof;

FIG. 9 is a perspective view of an alternative embodiment of the promotional assembly;

FIG. 10 is a back planar view of the promotional assembly of FIG. 9;

FIG. 11 is a perspective view of another alternative embodiment of the promotional assembly;

FIG. 12 is a back planar view of the promotional assembly of FIG. 11;

FIG. 13 is a perspective view of yet another alternative embodiment of the promotional assembly;

FIG. 14 is a back planar view of the promotional assembly of FIG. 13;

FIG. 15 is a perspective view of another alternative embodiment of the promotional assembly;

FIG. 16 is a back planar view of the promotional assembly of FIG. 15;

FIG. 17 is a cross-sectional view of the promotional assembly of FIG. 13;

FIG. 18 is another cross-sectional view of the promotional assembly of FIG. 13; and

FIG. 19 is a cross-sectional view of the promotional assembly of FIG. 13 illustrating a score line cut through a portion of the assembly.

### DETAILED DESCRIPTION OF THE PREFERRED EMBODIMENT

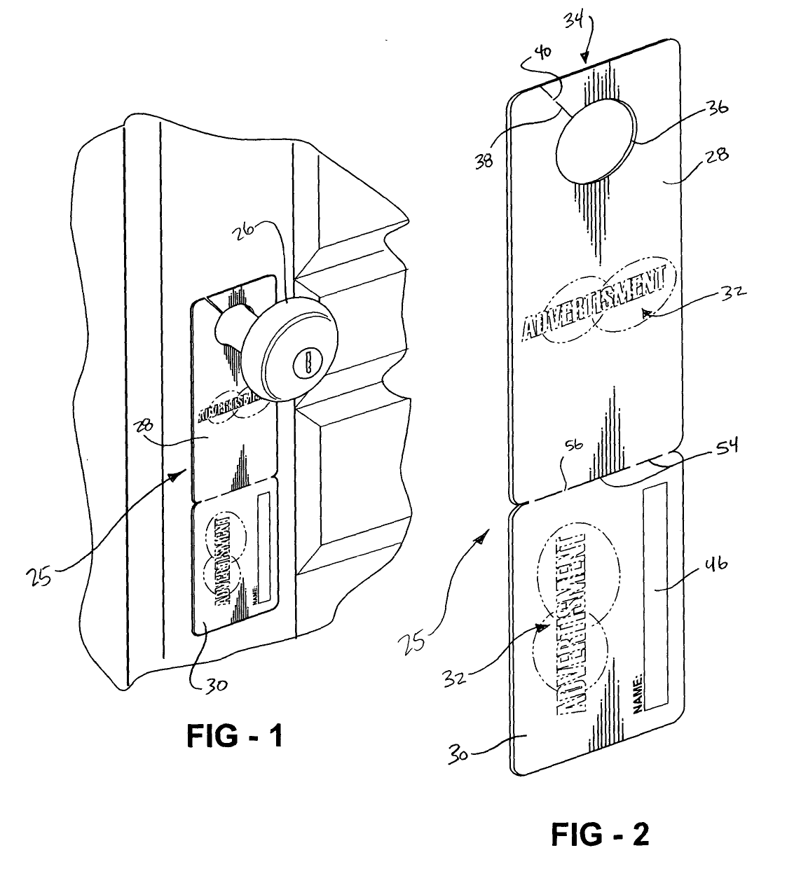

Referring to the Figures, wherein like numerals indicate like or corresponding parts throughout the several views, a promotional assembly is generally shown at 25 in FIGS. 1 and 2. The promotional assembly 25 is illustrated as being hung on a doorknob 26. For example, the employees or agents of an establishment advertised on the promotional assembly 25 may have distributed the promotional assembly 25 by placing the assembly 25 on a doorknob 26 of each housing in a neighborhood. It should be appreciated that the subject invention is in no way intended to be limited to such an application and in fact many other applications for the subject promotional assembly 25, such as hanging the promotional assembly 25 from a rear view mirror of a vehicle or using the promotional assembly 25 as a newspaper insert, have been contemplated by the applicants of the subject invention.

The first embodiment of the promotional assembly 25, which is illustrated in FIGS. 2-4, includes an advertising portion 28 and a coupon card portion 30. Variations of the promotional assembly 25, such as the ones subsequently discussed and the ones used in different applications, can be made without deviating from the overall scope of the subject invention.

Advertising areas 32 are disposed on the advertising portion 28 with the advertising areas 32 having promotional printed matter imprinted thereon for conveying various advertising information to a user and for providing a marketing aspect to the assembly. As illustrated, there are “ADVERTISEMENT”s disposed on both the front and back surfaces of the advertising portion 28. The promotional printed matter may be any variety of different information messages, advertisements, logos, etc., and may be of any size, color or shape as desired by a particular establishment.

The advertising portion 28 has a hanging section 34 defining an opening 36 for mounting the promotional assembly 25. As discussed above, the promotional assembly 25 may be mounted in any location, such as on a doorknob 26 or on a vehicle rear view mirror without deviating from the scope of the subject invention. Preferably, the opening 36 is substantially circular, such as shown. Further, the advertising portion 28 includes a slit 38 extending from the opening 36 to a periphery of the advertising portion 28 for allowing access to the opening 36. Most preferably, the advertising areas 32 are spaced from the opening 36 on the advertising portion 28. A connection point 40 is disposed within the slit 38 such that the hanging section 34 remains interconnected until manually manipulated by the user or customer.

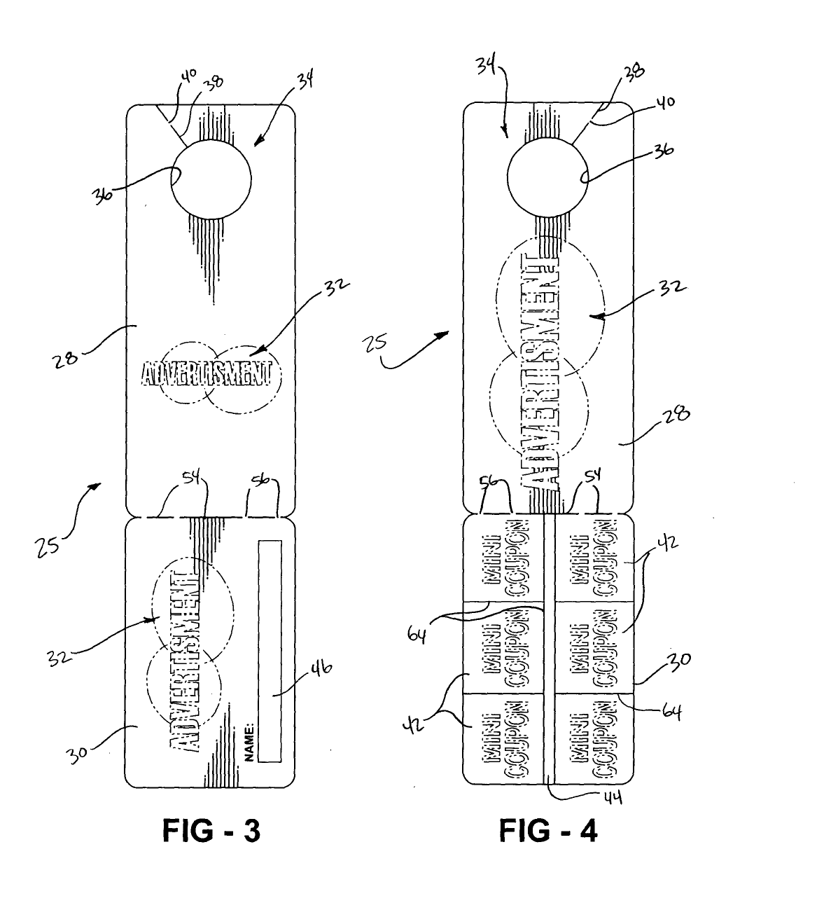

As shown in FIGS. 2 and 3, the coupon card portion 30 also preferably has at least one advertising area 32 with promotional printed matter imprinted thereon for providing an additional marketing aspect to the promotional assembly 25. Preferably, the front surface of the coupon card portion 30 includes the promotional printed matter such as logos, messages, or advertisements. Preferably, the front surface of the promotional assembly 25, see FIGS. 2 and 3, faces outwardly such that the customer or other user may view the advertising areas 32 on the front surface.

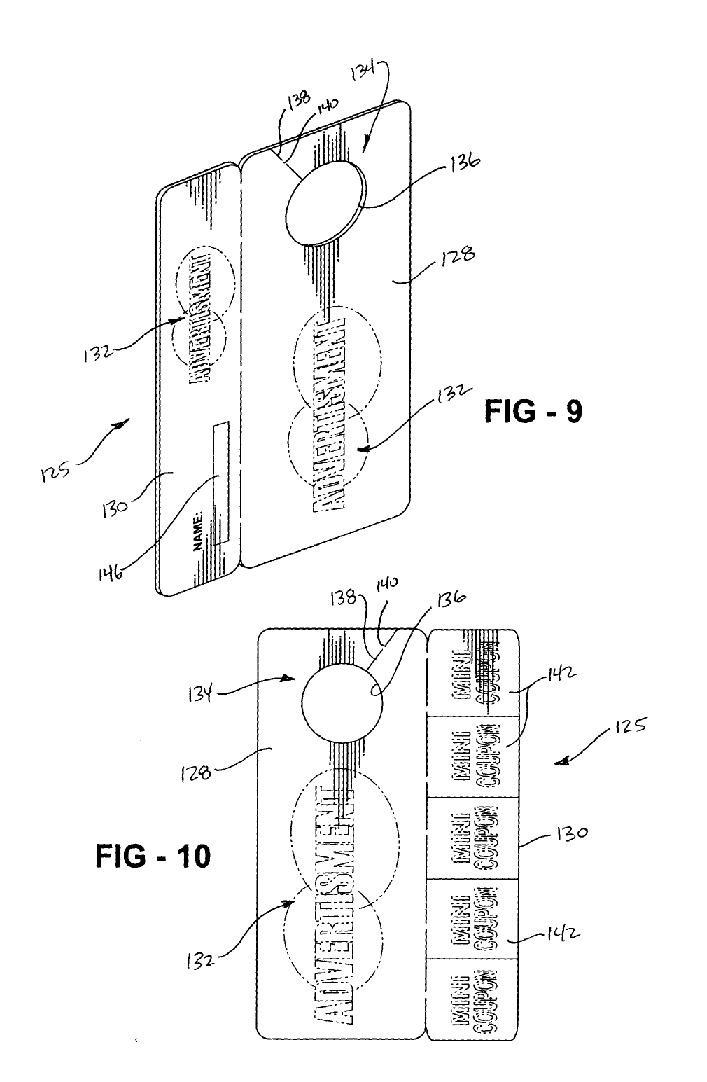

As shown in FIG. 4, the coupon card portion 30 has a plurality of removable mini-coupons 42 that can be subsequently detached from the coupon card portion 30 for allowing a user of the assembly 25 to redeem the mini-coupons 42. Preferably, the mini-coupons 42 are disposed on the back surface of the coupon card portion 30. An information area 44 can be positioned adjacent the mini-coupons 42 on the coupon card portion 30 for conveying selected information to a user, such as company information, patent numbers, etc. As illustrated, the information area 44 is positioned centrally to separate two rows of mini-coupons 42. As appreciated, the shape, size, or configuration of the mini-coupons 42 can be varied without deviating from the scope of the subject invention. In fact, a number of alternative mini-coupon configurations are illustrated in the alternative embodiments of FIGS. 9-12. The mini-coupons 42 of the promotional assembly 25, as provided by the coupon card portion 30, encourages the user or customer to return to the establishment. In addition, the coupon card portion 30 preferably has a rectangular configuration similar in size to a standard credit card. As shown in FIGS. 2 and 3, a customer name area 46 can be disposed on the front surface of the coupon card portion 30 in order to personalize the coupon card portion 30.

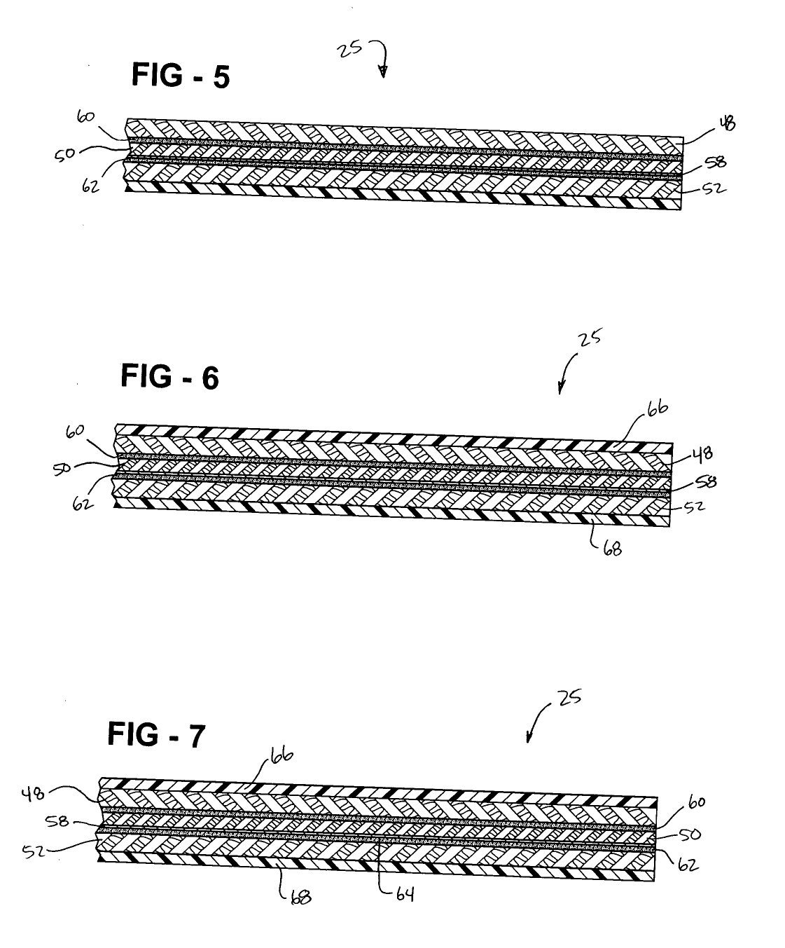

A preferred structure of the promotional assembly 25 is now discussed in greater detail with reference to FIGS. 5-7. The promotional assembly 25 comprises a first layer of material 48 having an exterior surface and an interior surface. A liner 50 is adhered to the interior surface of the first layer of material 48. A second layer of material 52 has an exterior surface and an interior surface with the interior surface of the second layer of material 52 adhered to the liner 50 to sandwich the liner 50 between the first 48 and second 52 layers of material.

Referring back to FIGS. 2-4, a plurality of first score lines 54 are cut through the first layer of material 48, the liner 50, and the second layer of material 52 to define the advertising portion 28 and the coupon card portion 30 with these portions being separable from each other. In the preferred embodiment, the plurality of first score lines 54 is further defined as a single series of transverse score lines 54 cutting completely across the advertising portion 28 and the coupon card portion 30. A plurality of connection points 56 are disposed between the plurality of first score lines 54 for maintaining interconnection between the advertising portion 28 and the coupon card portion 30 wherein the connection points 56 may be broken upon separation of the advertising portion 28 from the coupon card portion 30. The connection points 56 are areas of the promotional assembly 25 in which the first score lines 54 are not formed.

Turning back to FIGS. 5-7, when the promotional assembly 25 is constructed, the exterior surface of the first layer of material 48 becomes the front surface of the promotional assembly 25. The front surface is also shown in FIGS. 2 and 3. The exterior surface of the second layer of material 52 becomes the back surface of the promotional assembly 25. The back surface is also shown in FIG. 4. Preferably, the first 48 and second 50 layers of material are first 48 and second 50 layers of card stock of any suitable thickness, such as 10 mils. In addition, the liner 50 is preferably made of a clear polyester or paper material of any suitable thickness, such as 3.4 mils, having a silicone release coating 58 on one or more sides.

A first adhesive layer 60 is disposed between the interior surface of the first layer of card stock 48 and the liner 50 to adhere the first layer of card stock 48 to the liner 50. Similarly, a second adhesive layer 62 is disposed between the interior surface of the second layer of card stock 52 and the liner 50 to adhere the second layer of card stock 52 to the liner 50. As shown in FIG. 7, a plurality of second score lines 64 are cut through the second layer of material 52, i.e., the back surface, on the coupon card portion 30 to define the plurality of removable mini-coupons 42. Preferably, the plurality of second score lines 64 is further defined as an array of score lines partially cut through the coupon card portion 30. In the most preferred embodiment, the plurality of second score lines 64 are only cut through the coupon card portion 30 thereby leaving the advertising portion 28 free from the second score lines 64. It should be appreciated that mini-coupons 42 and/or other coupons can be disposed on either the front or back surfaces of the coupon card portion 30 or even the advertising portion 28 without deviating from the overall scope of the subject invention.

Preferably, the plurality of second score lines 64 cuts through the second adhesive layer 62 such that each of the mini-coupons 42 includes a portion of the second layer of card stock 52 and a portion of the second adhesive layer 62. The structural integrity of the coupon card portion 30, with the liner 50 and first layer of card stock 48, is maintained even after the mini-coupons 42 are removed.

The silicone release coating 58 on the one or more sides of the liner 50 allows the first 48 and/or second 52 layers of card stock, with the adhesive layer 60, 62 to be removed from the liner 50. In the most preferred embodiment, a silicone release coating 58 is disposed on a bottom side of the liner 50 such that the second layer of card stock 52 and second adhesive layer 62 of the mini-coupons 42 can be removed. The first layer of card stock 48 could be permanently adhered or “welded” to the liner 50.

As best shown in FIGS. 2-4, the advertising areas 32 are on the exterior surfaces of the advertising portion 28 and the printed matter is imprinted on at least one of the exterior surfaces of the first 48 and second 52 layers of card stock. Hence, the printed matter, which as discussed above, is preferably a variety of different information messages, advertisements, logos, coupons, etc., can be disposed on either or both of the front and back surfaces and may be of any size, color or shape. The advertising areas 32 and printed matter provide a marketing aspect to the promotional assembly 25.

Referring back to FIGS. 5-7, a first laminate layer 66 can be adhered to the exterior surface of the first layer of card stock 48 for protecting the first layer of card stock 48 (the front surface) and any printed matter thereon. As shown, FIG. 5 does not include this first laminate layer 66 and this layer 66 may not be applied such that a user can subsequently sign or otherwise write on the first layer of card stock 48. In particular, the user would write his/her name in the customer name area 46. A second laminate layer 68 is preferably adhered to the exterior surface of the second layer of card stock 52 for protecting the second layer of card stock 52 (the back surface) and any printed matter thereon. The specific construction of the promotional assembly 25 is preferably of the type disclosed in U.S. Pat. No. 5,417,458 to Best et al., which is herein incorporated by reference.

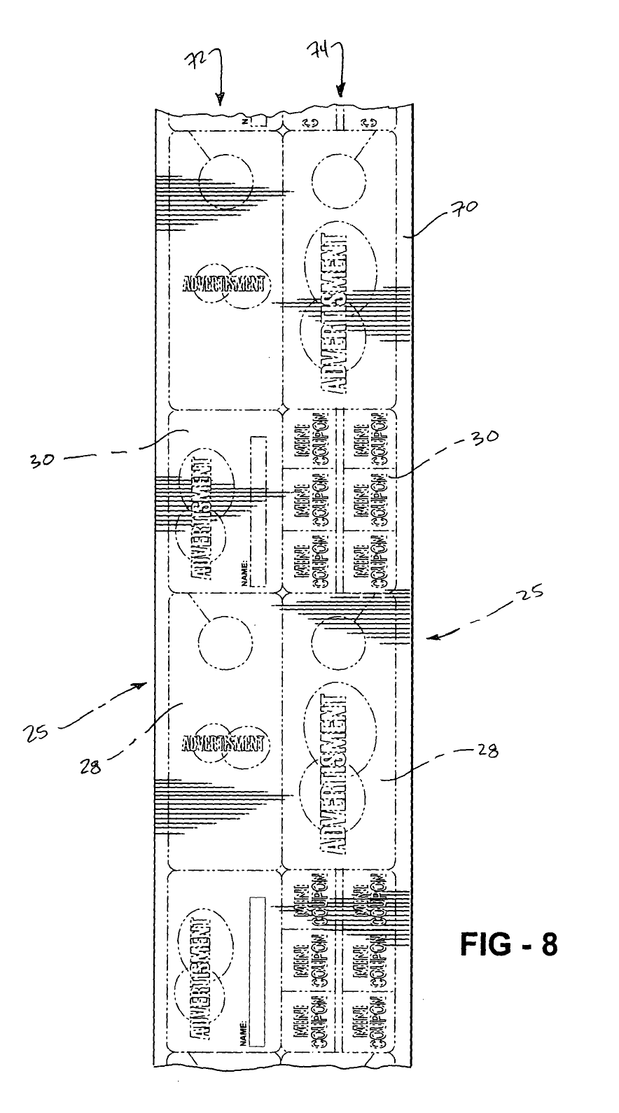

Referring to FIG. 8, one preferred method of manufacturing the promotional assembly 25 is now discussed in detail. The manufacture of the promotional assembly 25 initially begins with a single continuous sheet of card stock 70. The initial layout of the promotional assembly 25 has the front and back surfaces of the promotional assembly 25 being attached together and initially facing upward. Both the front and back surfaces include the single continuous sheet of card stock 70 with a continuous adhesive layer 60, 62 and a continuous liner 50 adhered to an underside thereof.

The sheet of card stock 70 is fed into a printing station (not shown) which prints the desired printed matter or indicia on the upward facing surfaces of the stock 70 in two parallel rows at the same time. As discussed above, the printed matter may be any desirable logos, messages, advertisements or the like. A certain amount of exterior material is disposed around the perimeter of the rows.

The parallel rows define a first strip 72 and a second strip 74 wherein the first strip 72 becomes the front surface of the promotional assembly 25 and the second strip 74 becomes the back surface of the promotional assembly 25. In other words, the front surface of FIG. 3 is illustrating the first strip 72 and the back surface of FIG. 4 is illustrating the second strip 74. As appreciated, the strips 72, 74 may be of any width or design to coordinate with the desired shape of the promotional assembly 25. In fact, different sized strips 72, 74 will be required to manufacture the promotional assemblies 25 of the alternative embodiments of FIGS. 9-12. A laminating device (not shown) can apply the clear laminate layer 66, 68 to the top surface of the card stock 70 on either or both of the strips 72, 74 for viewing the printed matter. In the embodiment shown in FIG. 5, the laminate layer 66 will not be applied to the first strip 72.

A cutting device (not shown) separates the continuous sheet of card stock 70 into the first 72 and second 74 strips. The second strip 74 is then inverted and the liner 50 is removed from the first strip 72. The silicone release coating 58 of the liner 50 allows the liner 50 to be removed from the adhesive layer 60 without removing the adhesive or damaging the sheet of card stock 70. The first 72 and second 74 strips are aligned and the adhesive layer 60 of the first strip 72 is moved into a bonded relationship with the liner 50 of the second strip 74. As appreciated, the printed matter of the first strip 72 should align with the printed matter of the second strip 74. The continuous sheet of card stock 70 having printed matter on the upward facing surfaces in two parallel rows has been transformed into a continuous series of two sided promotional assemblies 25. The first strip 72 is now the front surface of the promotional assembly 25 and the second strip 74 is now the back surface of the promotional assembly 25. In other words, there are now a plurality of interconnected promotional assemblies 25 with each assembly having 25 substantially the same printed matter disposed on each exterior surface of the first 48 and second 52 layers of material for creating the series of substantially identical promotional assemblies 25.

The back surface of the promotional assembly 25 is then scored by a scoring wheel (not shown) to form a perimeter of the mini-coupons 42. The scoring is substantial enough such that the mini-coupons 42 may be removed without affecting the adhesion of the remaining mini-coupons 42. Preferably, the scoring passes through the second laminate layer 66, layer of card stock 52, and second adhesive layer 62 of the second strip 74. The scoring does not, however, sever the liner 50 nor the layer of card stock 48 of the first strip 72. Each mini-coupon 42 is therefore preferably formed of the second laminate layer 68, second layer of card stock 52, and second adhesive layer 62 of the second strip 74. As appreciated, the coupon card portion 30 will preferably maintain the first laminate layer 66, first layer of card stock 48, and first adhesive layer 60 of the first strip 72 thereby ensuring structural integrity.

The series of promotional assemblies 25 passes under a punch wheel (not shown) for removing any exterior material from the bonded first 72 and second 74 strips. The punch wheel also creates the plurality of first score lines 54 between the coupon card portion 30 and the advertising portion 28. Hence, the punch wheel scores through the entire thickness of the promotional assembly 25 to outline the portions 28, 30. The plurality of connection points 56 are retained such that the advertising 28 and coupon card 30 portions remain loosely attached to each other. This specific method of manufacture is preferably of the type disclosed in U.S. Pat. Nos. 5,776,287 and 6,315,023, which are herein incorporated by reference.

Referring to FIGS. 9 and 10, an alternative embodiment of the promotional assembly is disclosed wherein like numerals increased by 100 indicate like or corresponding parts. In this alternative embodiment, the coupon card portion 130 is mounted to a side of the advertising portion 128. Hence, the promotional assembly 125 of FIGS. 9 and 10 is wider than the promotional assembly 25 of FIGS. 2-4. The mini-coupons 142 are spaced equidistantly along the coupon card portion 130 in a single row to form substantially square mini-coupons 142. The information area has also been removed. The remaining aspects of the promotional assembly 125 in FIGS. 9 and 10 are substantially the same as the promotional assembly 25 in FIGS. 2-4.

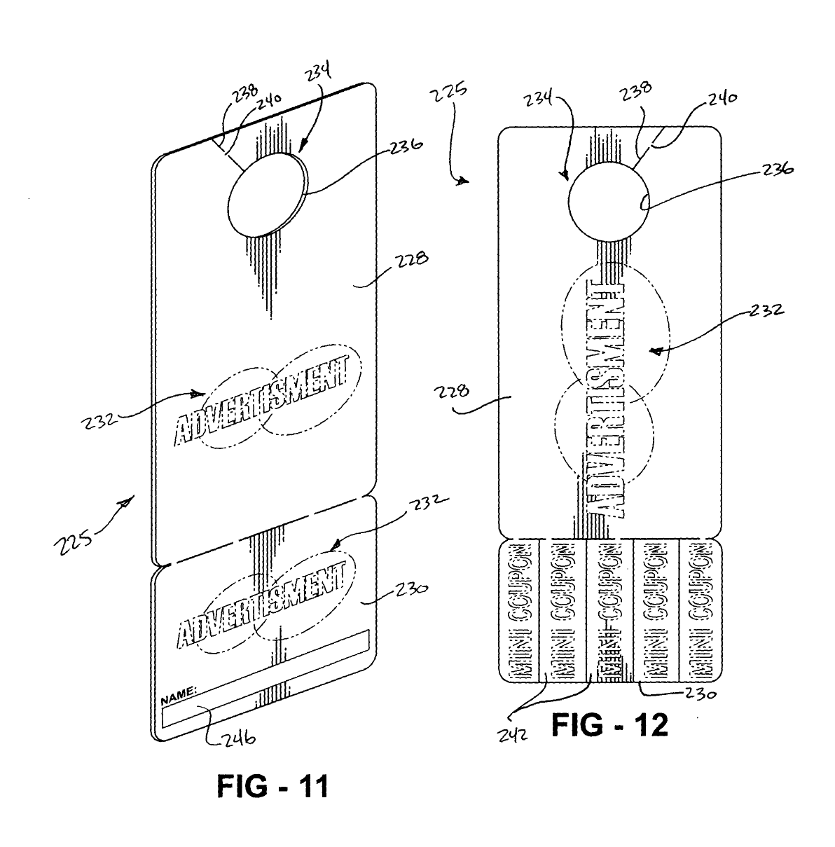

Referring to FIGS. 11 and 12, yet another alternative embodiment of the promotional assembly is shown wherein like numerals increased by 200 indicate like or corresponding parts. In this embodiment, the promotional assembly 225 has the coupon card portion 230 turned sideways or 180 degrees from the promotional assembly 225 shown in FIGS. 2-4. Hence, the promotional assembly 225 of FIGS. 11 and 12 is also wider than the promotional assembly 25 of FIGS. 2-4. In addition, the mini-coupons 242 extend across the entire width of the coupon card portion 230 and the information area is removed. The remaining aspects of the promotional assembly 225 of FIGS. 11 and 12 are substantially the same as the promotional assembly 25 of FIGS. 2-4.

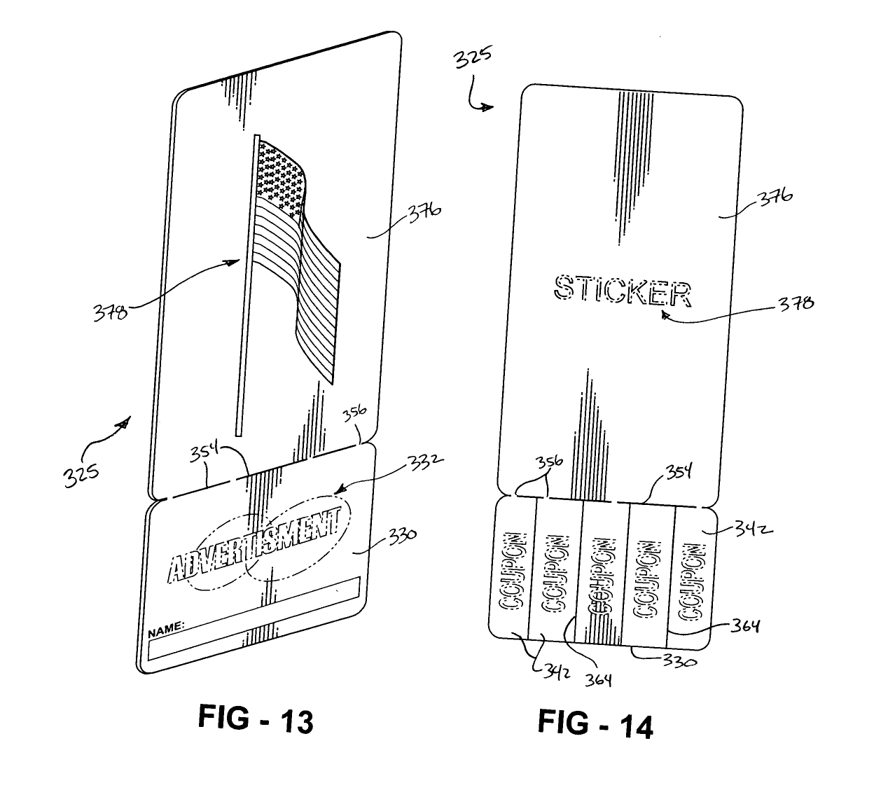

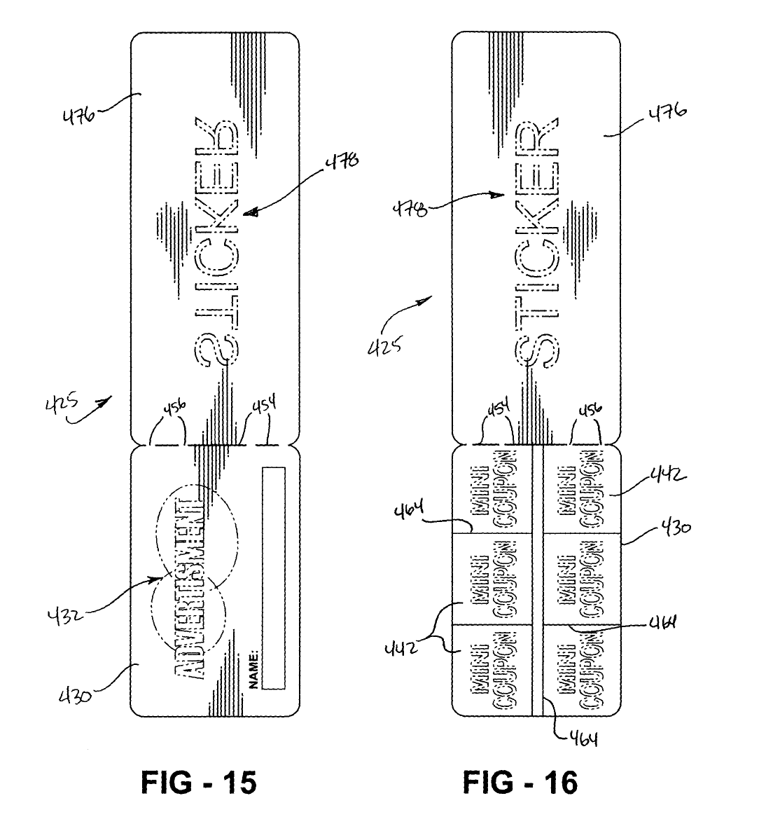

Referring to FIGS. 13-16, two additional alternative embodiments are shown wherein like numerals increased by 300, for FIGS. 13-14, and like numerals increased by 400, for FIGS. 15-16, indicated like or corresponding parts. The promotional assembly 325 of FIGS. 13 and 14 is somewhat similar to the promotional assembly 225 of FIGS. 11 and 12, i.e., the coupon card portion 330 has been turned sideways. Also, the promotional assembly 425 of FIGS. 15 and 16 is somewhat similar to the promotional assembly 25 of FIGS. 2-4. These alternative embodiments, however, are substantially different from the promotional assemblies 25, 225 of FIGS. 2-4 and 11-12 as is discussed in greater detail below.

One primary difference is that the promotional assembles 325, 425 of FIGS. 13-16 do not include an opening or a slit for mounting the promotional assembly. The promotional assemblies 325, 425 illustrated in FIGS. 13-16 include a sticker portion 376, 476, and a coupon card portion 330, 430. As is discussed in greater detail below, these promotional assemblies 325, 425 incorporate a structure that allows the assemblies 325, 425 to be adhered to a substrate, such as a vehicle bumper, a vehicle windshield, windows, a package, a product, or any other suitable surface.

Printed matter 378, 478 is imprinted on at least one of the front and back surfaces of the sticker portion 376, 476 for conveying various pictorial, graphical, and text messages to the user. Hence, the sticker portion 376, 476 can include any suitable logo, message, image, advertisement, company information, contact information, picture, graphic, or the like. As illustrated in FIG. 13, the printed matter 378 on the front surface of the sticker portion 376 is a United States flag. Printed matter is also imprinted on the coupon card portion 330, 430. Preferably, the coupon card portion 330, 430 has at least one advertising area 332, 432 with promotional printed matter imprinted thereon for providing an additional marketing aspect to the promotional assembly 325, 425. The promotional printed matter on the coupon card portion 330, 430 may be any desired logo, informational messages, advertisements, or the like. As with the other embodiments, the coupon card portion 330, 430 preferably has a rectangular configuration similar in size to a standard credit card. As appreciated, the logos, messages, and advertisements may be of any size, color, or shape to fit within the coupon card portion 330, 430 as desired by a particular vendor. As appreciated, the type of information imprinted on the assembly 325, 425 will vary with each vendor.

As shown in FIGS. 14 and 16, the coupon card portion 330, 430 has a plurality of removable mini-coupons 342, 442 that can be subsequently detached from the coupon card portion 330, 430 for allowing the user of the assembly 325, 425 to redeem the mini-coupons 342, 442 in addition to utilizing the sticker portion 376, 476. The mini-coupons 342, 442 of the promotional assembly 325, 425, as provided by the coupon card portion 330, 430, encourages the user or customer to return to the establishment.

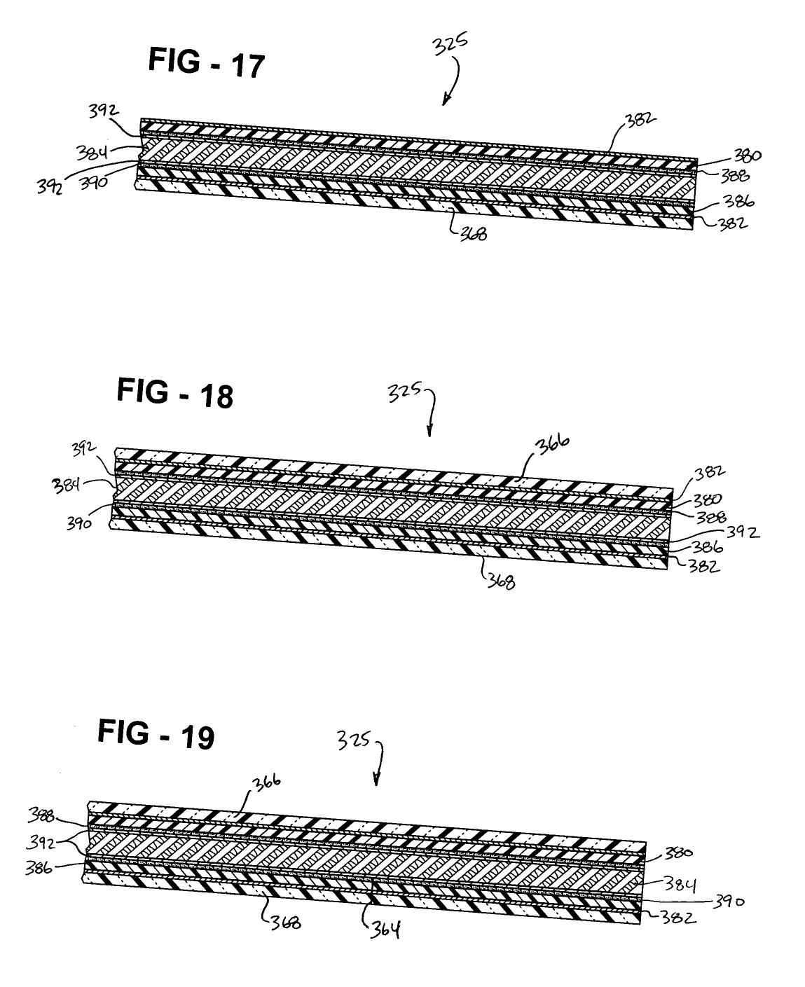

A preferred structure of the promotional assembly 325 of FIGS. 13 and 14 is discussed in greater detail with reference to FIGS. 17-19. Although not specifically discussed, it should be appreciated that the structure of the promotional assembly 425 of FIGS. 15 and 16 is substantially the same as the structure herein described with reference to FIGS. 17-19. Specifically, the promotional assemblies 325 of FIGS. 13 and 14 includes a first flexible film layer 380 having an exterior surface and an interior surface and a preferable thickness of from 1.0 mil to 8.0 mils. The thickness of the first flexible film layer 380 is more preferably from 3.0 mils to 5.0 mils. Most preferably, the thickness of the first flexible film layer 380 is from 3.4 mils to 4.0 mils. The first flexible film layer 380 is formed of a compound that is relatively thin and flexible. In particular, the first flexible film layer 380 is formed of a compound that is selected from the group consisting of acrylic, acetate, diacetate, polyester, polycarbonate, polyethylene, polypropylene, polystyrene, polyethylene naphthalate, polyvinylfluoride, polyimide, polyolefin, polyethylene fibers, and vinyl. More preferably, the first flexible film layer 380 is formed of a substantially clear or substantially opaque vinyl compound, such as PVC. Vinyl has many desirable characteristics such as flexibility and resistance to tearing. A thin flexible film layer 380 of this type can be obtained from FLEXcon under the designation V 400 H.

The first flexible film layer 380 preferably also includes a top coat 382 defining the exterior surface of the assembly 325 with the top coat 382 allowing printed matter to be imprinted on the exterior surface. The top coat 382 is essentially a surface treatment that improves ink adhesion to the first flexible film layer 380. The choice of top coat 382 will depend on how the film layer 380 is to be printed, i.e., flexographic, thermal transfer, offset printing, etc. The thickness of the top coat 382 is exaggerated in the figures for illustrative purposes and does not actually add to the thickness of the first flexible film layer 380.

A liner 384 is adhered to the interior surface of the first flexible film layer 380 with the liner 384 being formed of a paper card stock preferably having a thickness of from 2.8 mils to 9.0 mils. The liner 384 is preferably a bleached white clay-coated kraft that is intended for roll-to-sheet applications as is known in the art. More preferably, the liner 384 has a thickness of from 3.8 mils to 8.1 mils and most preferably the liner 384 has a thickness of from 6.0 mils to 8.0 mils. The liner 384 for the promotional assemblies 325 of FIGS. 13-14 is substantially thicker than the liner of the promotional assemblies 25, 125 of FIGS. 2-4 and 9-12 due to the first flexible film layer 380 being substantially thinner. The thicker liner 384 compensates for the thin film layer 380 to ensure that the promotional assembly 325 maintains a desired structural integrity. In particular, the liner 384 has a thickness that is larger than the thicknesses of each of the first flexible film layer 380 and second flexible film layer 386 (discussed below). Preferably, the liner 384 has a thickness that is at least one and one half times larger than the thickness of each of the first 380 and second flexible 386 film layers.

A second flexible film layer 386 has an exterior surface and an interior surface and a preferred thickness of from 1.0 mil to 8.0 mils. The second flexible film layer 386 is structurally identical to the first flexible film layer 380. The interior surface of the second flexible film layer 386 is adhered to the liner 384 to sandwich the liner 384 between the first 380 and second 386 flexible film layers. As with the first flexible film layer 380, the second flexible film layer 386 has a more preferred thickness of from 3.0 mils to 5.0 mils and a most preferred thickness of from 3.4 mils to 4.0 mils. Further, the second flexible film layer 386 is preferably formed of a compound selected from the group consisting of acrylic, acetate, diacetate, polyester, polycarbonate, polyethylene, polypropylene, polystyrene, polyethylene naphthalate, polyvinylfluoride, polyimide, polyolefin, polyethylene fibers, and vinyl. More preferably, the second flexible film layer 386 is formed of a substantially clear or substantially opaque vinyl compound, such as PVC. The thin flexible film layer 380 of this type can be obtained from FLEXcon under the designation V 400 H.

The second flexible film layer 386 also preferably includes a top coat 382 defining the exterior surface of the assembly 325 with the top coat 382 providing a surface treatment which allows printed matter to be imprinted on the exterior surface. Again, the thickness of the top coat 382 is exaggerated in the figures for illustrative purposes and does not actually add to the thickness of the second flexible film layer 386.

Referring back to FIGS. 13-14, a plurality of first score lines 354 are cut through the first flexible film layer 380, the liner 384, and the second flexible film layer 386 to define the sticker portion 376 and the coupon card portion 330 with the portions 330, 376 being separable from each other. Preferably, the plurality of first score lines 354 is further defined as a single series of transverse score lines 354 cutting completely across the sticker portion 376 and the coupon card portion 330. A plurality of connection points 356 are disposed between the plurality of first score lines 354 for maintaining interconnection between the sticker portion 376 and the coupon card portion 330 wherein the connection points 356 may be broken upon separation of the sticker portion 376 from the coupon card portion 330.

At least one of the first 380 and second 386 flexible film layers on the sticker portion 376 is removable from the liner 384 for allowing a user to transpose the first 380 and second 386 flexible film layers from the sticker portion 376 to another substrate. As illustrated, each first 380 and second 386 flexible film layer defines only one sticker. In particular, the printed matter 378 is imprinted on at least one of the exterior surfaces of the sticker portion 376 for conveying the various pictorial, graphical, and text messages to the user thereby encouraging the user to remove at least one of the first 380 and second 386 flexible film layers on the sticker portion 376. Hence, the first 380 and/or second 386 flexible film layers can include any suitable logo, message, advertisement, picture, graphic, or the like such that these layers operate as the sticker.

Alternatively as shown in FIG. 15, at least some of the printed matter 478 imprinted on one of the exterior surfaces of the sticker portion 476 is imprinted as a mirror image to define a mirror image sticker. This film layer is designed to be affixed to an interior surface of a window and viewed from outside the window. In other words, the mirror image is viewed as normal printing from outside of the window. The promotionally assembly 425 of FIG. 15 includes both normal and mirror image printing thereon.

Turning back to FIGS. 17-19, a first adhesive layer 388 is disposed between the interior surface of the first flexible film layer 380 and the liner 384 to adhere the first flexible film layer 380 to the liner 384. A second adhesive layer 390 is disposed between the interior surface of the second flexible film layer 386 and the liner 384 to adhere the second flexible film layer 386 and the liner 384. Preferably, the first 388 and second 390 adhesive layers are formed of an acrylic based removable adhesive that prevents depositing of a residue upon subsequent removal from a substrate. Typical adhesives of this type are from 0.5 to 1.0 mils thick but could be as thick as 3.9 to 4.1 mils. An adhesive of this type can be obtained from FLEXcon under the designation V-327.

As shown in FIG. 19, a plurality of second score lines 364 are cut through the second flexible film layer 386 on the coupon card portion 330 to define the plurality of removable mini-coupons 342 that can be subsequently detached from the coupon card portion 330 for allowing the user of the assembly 325 to redeem the mini-coupons 342 in addition to utilizing the sticker portion 376. Preferably, the plurality of second score lines 364 is further defined as an array of score lines 364 partially cut through the coupon card portion 330. As with the embodiments of FIGS. 2-4 and 9-12, the plurality of second score lines 364 further cuts through the second adhesive layer 390 such that each of the mini-coupons 342 includes a portion of the second flexible film layer 386 and a portion of the second adhesive layer 390. Preferably, the plurality of second score lines 364 are only cut through the coupon card portion 330 thereby leaving the sticker portion 376 free from the second score lines 364.

A release coating 392 is disposed between the liner 384 and the second adhesive layer 390 such that the mini-coupons 342 are removable from the liner 384 without damaging the liner 384 or the mini-coupons 342. Preferably, a release coating 392 is disposed between the liner 384 and both the first 388 and second 390 adhesive layers such that both of the first 380 and second 386 flexible film layers on the sticker portion 376 are removable from the liner 384 without damaging the liner 384 or the sticker portion 376 and wherein the first 388 and second 390 adhesive layers remain attached to the first 380 and second 386 flexible film layers (the stickers), respectively, during the removal.

A first laminate layer 366 is adhered to the exterior surface of the first flexible film layer 380 for protecting the first flexible film layer 380 and any printed matter thereon and a second laminate layer 368 adhered to the exterior surface of the second flexible film layer 386 for protecting the second flexible film layer 386 and any printed matter thereon. As shown in FIG. 17, the first laminate layer 366 may be eliminated, if desired.

The preferred method of using the promotional assemblies 325, 425 of FIGS. 13-19 includes removing the coupon card portion 330, 430 from the sticker portion 376, 476. The first and second flexible film layers, which define the stickers, can then be peeled from the liner of the sticker portion 376, 476 and attached to any surface. The mini-coupons 342, 442 can also be peeled from the coupon card portion 330, 430 and redeemed at any participating establishment.

The preferred method of manufacturing the promotional assemblies 325, 425 of FIGS. 13-19 is similar to the method of manufacture outlined above and illustrated in FIG. 8. In particular, the manufacture of the promotional assemblies 325, 425 initially begins with a single continuous sheet of pressure sensitive film. The initial layout of the promotional assemblies 325, 425 has the front and back surfaces of the promotional assemblies 325, 425 being attached together and initially facing upward. Both the front and back surfaces include the single continuous sheet of film with a continuous adhesive layer and a continuous liner adhered to an underside thereof.

The sheet of film is fed into a printing station (not shown) which prints the desired printed matter on the upward facing surfaces of the film in two parallel rows at the same time. The parallel rows define a first strip and a second strip wherein the first strip becomes the front surface of the promotional assembly 325, 425 and the second strip becomes the back surface of the promotional assembly 325, 425. A laminating device (not shown) can apply the clear laminate layer to the top surface of the film on either or both of the strips for viewing the printed matter.

A cutting device (not shown) separates the continuous sheet of film into the first and second strips. The second strip is then inverted and the liner is removed from the first strip. The first and second strips are aligned and the adhesive layer of the first strip is moved into a bonded relationship with the liner of the second strip. As appreciated, the printed matter of the first strip should align with the printed matter of the second strip. The continuous sheet of film having printed matter on the upward facing surfaces in two parallel rows has been transformed into a continuous series of two sided promotional assemblies 325, 425. The first strip is now the front surface of the promotional assembly 325, 425 and the second strip is now the back surface of the promotional assembly 325, 425. In other words, there are now a plurality of interconnected promotional assemblies 325, 425 with each assembly 325, 425 having substantially the same printed matter disposed on each exterior surface of the first and second flexible film layers for creating the series of substantially identical promotional assemblies 325, 425.

Obviously, many modifications and variations of the present invention are possible in light of the above teachings and the invention may be practiced otherwise than as specifically described within the scope of the appended claims.

What is claimed is:

1. A promotional assembly comprising:
a first layer of material having an exterior surface and an interior surface;
a liner adhered to said interior surface of said first layer of material;
a second layer of material having an exterior surface and an interior surface with said interior surface of said second layer of material adhered to said liner to sandwich said liner between said first and second layers of material;
a plurality of first score lines cut through said first layer of material, said liner, and said second layer of material to define an advertising portion and a coupon card portion with said portions being separable from each other;
said advertising portion having a hanging section defining an opening for mounting said assembly;
advertising areas on said exterior surfaces of said advertising portion with said advertising areas having promotional printed matter imprinted on at least one of said exterior surfaces for conveying various advertising information to a user and for providing a marketing aspect to said assembly; and
a plurality of second score lines cut through said second layer of material on said coupon card portion to define a plurality of removable mini-coupons that can be subsequently detached from said coupon card portion for allowing a user of said assembly to redeem said mini-coupons.

2. An assembly as set forth in claim 1 wherein said opening is substantially circular.

3. An assembly as set forth in claim 1 wherein said advertising portion includes a slit extending from said opening to a periphery of said advertising portion for allowing access to said opening.

4. An assembly as set forth in claim 1 wherein said advertising areas are spaced from said opening on said advertising portion.

5. An assembly as set forth in claim 1 wherein said plurality of second score lines are only cut through said coupon card portion thereby leaving said advertising portion free from said second score lines.

6. An assembly as set forth in claim 1 wherein said plurality of first score lines is further defined as a single series of transverse score lines cutting completely across said advertising portion and said coupon card portion.

7. An assembly as set forth in claim 6 wherein said plurality of second score lines is further defined as an array of score lines partially cut through said coupon card portion.

8. An assembly as set forth in claim 1 wherein said first and second layers of material are further defined as first and second layers of card stock, respectively.

9. An assembly as set forth in claim 8 further including a first adhesive layer disposed between said interior surface of said first layer of card stock and said liner to adhere said first layer of card stock to said liner, and further including a second adhesive layer disposed between said interior surface of said second layer of card stock and said liner to adhere said second layer of card stock and said liner.

10. An assembly as set forth in claim 9 wherein said plurality of second score lines further cuts through said second adhesive layer such that each of said mini-coupons includes a portion of said second layer of card stock and a portion of said second adhesive layer.

11. An assembly as set forth in claim 9 further including printed matter imprinted on at least one of said exterior surfaces of said coupon card portion.

12. An assembly as set forth in claim 11 further including a first laminate layer adhered to said exterior surface of said first layer of card stock for protecting said first layer of card stock and any printed matter thereon and a second laminate layer adhered to said exterior surface of said second layer of card stock for protecting said second layer of card stock and any printed matter thereon.

13. An assembly as set forth in claim 1 further including a plurality of connection points disposed between said plurality of first score lines for maintaining interconnection between said advertising portion and said coupon card portion wherein said connection points may be broken upon separation of said advertising portion from said coupon card portion.

14. An assembly as set forth in claim 1 further including a plurality of interconnected promotional assemblies with each assembly having substantially the same printed matter disposed on each exterior surface of said first and second layers of material for creating a series of substantially identical promotional assemblies.

15. A promotional assembly comprising:
a first flexible film layer having an exterior surface and an interior surface and a thickness of from 1.0 mil to 8.0 mils;
a liner adhered to said interior surface of said first flexible film layer with said liner being formed of a paper card stock having a thickness of from 2.8 mils to 9.0 mils;
a second flexible film layer having an exterior surface and an interior surface and a thickness of from 1.0 mil to 8.0 mils with said interior surface of said second flexible film layer adhered to said liner to sandwich said liner between said first and second flexible film layers;
a plurality of first score lines cut through said first flexible film layer, said liner, and said second flexible film layer to define a sticker portion and a coupon card portion with said portions being separable from each other, at least one of said first and second flexible film layers on said sticker portion being removable from said liner for allowing a user to transpose said first and second flexible film layers from said sticker portion to another substrate;
printed matter imprinted on at least one of said exterior surfaces of said sticker portion for conveying various pictorial, graphical, and text messages to the user thereby encouraging the user to remove at least one of said first and second flexible film layers on said sticker portion; and
a plurality of second score lines cut through said second flexible film layer on said coupon card portion to define a plurality of removable mini-coupons that can be subsequently detached from said coupon card portion for allowing the user of said assembly to redeem said mini-coupons in addition to utilizing said sticker portion.

16. An assembly as set forth in claim 15 wherein said first and second flexible film layers have a thickness of from 3.0 mils to 5.0 mils.

17. An assembly as set forth in claim 16 wherein said liner has a thickness of from 3.8 mils to 8.1 mils.

18. An assembly as set forth in claim 15 wherein said liner has a thickness that is larger than said thicknesses of each of said first and second flexible film layers.

19. An assembly as set forth in claim 15 wherein said liner has a thickness that is at least one and one half times larger than said thickness of each of said first and second flexible film layers.

20. An assembly as set forth in claim 15 wherein said first and second flexible film layers are formed of a compound selected from the group consisting of acrylic, acetate, diacetate, polyester, polycarbonate, polyethylene, polypropylene, polystyrene, polyethylene naphthalate, polyvinylfluoride, polyimide, polyolefin, polyethylene fibers, and vinyl.

21. An assembly as set forth in claim 15 wherein said first and second flexible film layers are formed of a substantially clear vinyl compound.

22. An assembly as set forth in claim 15 wherein said first and second flexible film layers are formed of a substantially opaque vinyl compound.

23. An assembly as set forth in claim 15 wherein each of said first and second flexible film layers includes a top coat defining said exterior surfaces with said top coat allowing said printed matter to be imprinted on said exterior surfaces.

24. An assembly as set forth in claim 15 further including a first adhesive layer disposed between said interior surface of said first flexible film layer and said liner to adhere said first flexible film layer to said liner, and further including a second adhesive layer disposed between said interior surface of said second flexible film layer and said liner to adhere said second flexible film layer and said liner.

25. An assembly as set forth in claim 24 wherein said first and second adhesive layers are formed of an acrylic based removable adhesive that prevents depositing of a residue upon subsequent removal from a substrate.

26. An assembly as set forth in claim 24 wherein said plurality of second score lines further cuts through said second adhesive layer such that each of said mini-coupons includes a portion of said second flexible film layer and a portion of said second adhesive layer.

27. An assembly as set forth in claim 26 wherein said plurality of second score lines are only cut through said coupon card portion thereby leaving said sticker portion free from said second score lines.

28. An assembly as set forth in claim 26 further including a release coating disposed between said liner and said second adhesive layer such that said mini-coupons are removable from said liner without damaging said liner or said mini-coupons.

29. An assembly as set forth in claim 28 wherein said second flexible film layer on said sticker portion is removable from said liner without damaging said liner or said sticker portion and wherein said second adhesive layer remains attached to said second flexible film layer on said sticker portion during said removal.

30. An assembly as set forth in claim 24 further including a release coating disposed between said liner and said first and second adhesive layers such that both of said first and second flexible film layers on said sticker portion are removable from said liner without damaging said liner or said sticker portion and wherein said first and second adhesive layers remain attached to said first and second flexible film layers, respectively, during said removal.

31. An assembly as set forth in claim 30 wherein at least some of said printed matter imprinted on one of said exterior surfaces of said sticker portion is imprinted as a mirror image to define a mirror image sticker.

32. An assembly as set forth in claim 15 wherein said plurality of first score lines is further defined as a single series of transverse score lines cutting completely across said sticker portion and said coupon card portion.

33. An assembly as set forth in claim 32 wherein said plurality of second score lines is further defined as an array of score lines partially cut through said coupon card portion.

34. An assembly as set forth in claim 24 further including printed matter imprinted on at least one of said exterior surfaces of said coupon card portion.

35. An assembly as set forth in claim 34 further including a first laminate layer adhered to said exterior surface of said first flexible film layer for protecting said first flexible film layer and any printed matter thereon and a second laminate layer adhered to said exterior surface of said second flexible film layer for protecting said second flexible film layer and any printed matter thereon.

36. An assembly as set forth in claim 15 further including a plurality of connection points disposed between said plurality of first score lines for maintaining interconnection between said sticker portion and said coupon card portion wherein said connection points may be broken upon separation of said sticker portion from said coupon card portion.

37. An assembly as set forth in claim 15 further including a plurality of interconnected promotional assemblies with each assembly having substantially the same printed matter disposed on each exterior surface of said first and second flexible film layers for creating a series of substantially identical promotional assemblies.
